(19) United States
(12) Patent Application Publication
(10) Pub. No.: US 2006/0018201 A1
(43) Pub. Date: Jan. 26, 2006

(54) Method of and device for setting and indicating a plurality of alerts using an indicator hand

(76) Inventor: Ronald S. Lizzi, Bethany, CT (US)

Correspondence Address: Arthur G. Schaier;Carmody & Torrance LLP, 50 Leavenworth Street, P.O. Box 1110, Waterbury, CT, 06721-1110, US

(21) Appl. No.: 10/894,901

(22) Filed: Jul. 20, 2004

(51) Int. Cl. G04B 23/02; G08B 29/00

(52) U.S. Cl. 368/244; 340/511; 340/691.1

(57) ABSTRACT

A method of manually setting and viewing a plurality of alerts in a multimode electronic device, and a device for carrying out the method. The setting and viewing of the alert settings is performed with the aid of a single indicator hand. In this way, an analog timepiece can store a plurality of alarm settings without multiple hands.

### BACKGROUND OF THE INVENTION

The present invention is directed generally to multimode electronic devices, such as timepieces generally and wristwatches specifically (but not limitation), and, in particular, to a novel method of and multimode electronic device for setting and indicating a plurality of alerts using an indicator hand. More specifically, the present invention provides unique constructions and methodologies for displaying information with the use of hands, such as that found in analog watches (i.e. in an “analog manner”).

Originally, watches were typically viewed merely as devices for telling time. Over time, alarm features have been incorporated into the watches so that a user could store a meeting (or other alert) time. In “purely” digital watches (i.e. those displaying time on an LCD and having no hands (e.g. so as to be distinguished from a “combo” watch which comprises both an analog display of information (i.e. using hands) and a digital display (see U.S. Pat. No. 5,691,962 as but one example)), setting and indicating multiple alarms is relatively easy since the setting of alerts (and the indication thereof) can all be done with relative ease.

Setting and viewing alerts in watches that display time and/or other information using hands has been more challenging. Use of the bezel ring for providing an alert setting, such as that described in U.S. Pat. Nos. 5,742,565 and 5,305,291, are but two examples of setting an alarm in an analog watch.

Accordingly, it can be seen that further advancements in the art are desired. In particular, it is desirable to provide an improved method of and a device for setting and indicating a plurality of alerts using an indicator hand. In a known prior art device sold under the Bulova name, two alert settings are achievable. However, in such a device, an alert indexer (i.e. a mode hand) is needed to index between the two alert settings. Moreover, the prior art of which Applicant is aware is deficient in being able to automatically update the indicator hand to a next upcoming alert, in order to provide a user with advance indication of the next alert setting. This feature is extremely advantageous in a device of the kind disclosed herein when more than one alert setting is storable. It is believed that the functionality and methodologies to provide such additional advantages and achieve additional objectives are provided by the present invention.

### SUMMARY AND OBJECTIVES OF THE INVENTION

It is thus an objective of the present invention to overcome the perceived deficiencies in the prior art.

Specifically, it is an objective of the present invention to provide a method of and a device for setting and indicating a plurality of alerts using an indicator hand in an analog watch, although as will become clear below, the electronic device need not be limited to a watch.

Another object of the present invention is to provide an improved method of manually setting a plurality of alerts with a single indicator hand and without a separate visual alert indexer to visually index alert settings, such that the number of settable alerts is not dictated by the need to provide, or spacing requirements of, a visual alert indexer to correspondingly index the alert settings.

Yet a further object of the present invention is to provide a method of viewing, with an indicator hand, multiple alert settings, wherein all alerts are viewed with a single indicator hand without a separate visual alert indexer to visually index the alert settings.

Still further, an objective of the present invention is to provide an improved device having alerts that can be set more than twelve (12) hours in advance without the need for a separate a.m./p.m. indicator to indicate whether the indicator hand is indicating an alert setting that is greater than 12 hours subsequent to the initial time (e.g. then current time of day).

It is yet another object of the present invention to provide a method of and a device for automatically updating the indicator hand to a next upcoming alert, in order to provide a user with advance indication of the next alert setting, an advantage in a device of the kind disclosed herein whereby more than one alert setting is storable.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

To overcome the perceived deficiencies in the prior art and to achieve the objects and advantages set forth above and below, the present invention is, generally speaking, directed to several embodiments, one of which is a method of manually setting a plurality of alerts in a multimode electronic device, wherein the method is achieved with a single indicator hand without a separate visual alert indexer to visually index alert settings, wherein the method comprises the steps of rotating an indicator hand to a first position corresponding to a first desired alert setting; setting a first alert associated with the indicator hand being in the first position, rotating the indicator hand to a second position corresponding to a second desired alert setting; and setting a second alert associated with the indicator hand being in the second position; wherein the settings for both the first alert and the second alert are stored prior to the indication of either the first and second alerts; and wherein the number of settable alerts is not dictated by the need to provide, or spacing requirements of, a visual alert indexer to correspondingly index the alert settings.

In another aspect of the present invention, a method of viewing, with an indicator hand, a plurality of alert settings is provided, and in a preferred embodiment, comprises the steps of, from an initial position, initiating a rotation of the indicator hand to a position corresponding to the first alert setting; and from either the initial position or the position corresponding to the first alert setting, initiating a rotation of the indicator hand to a position corresponding to the second alert setting; wherein all alerts are viewed with a single indicator hand without a separate visual alert indexer to visually index the alert settings.

In yet another aspect of the present invention, and to fully achieve the objective wherein alerts can be set more than twelve (12) hours in advance of an initial time, the present invention comprises viewable demarcations spanning a time-period of greater than twelve (12) hours; means for causing the actuation mechanism to rotate the indicator hand from an initial position to a first position corresponding to a desired alert setting, wherein the desired alert setting corresponds to a time that is more than twelve (12) hours subsequent to a time represented by the initial position; means for setting a first alert associated with the indicator hand being in the first position; wherein the first alert activates at a time that is more than twelve (12) hours subsequent to the time represented by the initial position, and wherein only a single indicator hand is used without a separate am/pm indicator to indicate whether the indicator hand is indicating an alert setting that is greater than 12 hours subsequent to the time represented by the initial position.

In still another aspect of the present invention, a method of indicating, with an indicator hand, an upcoming alert setting in a multimode electronic device is provided, and in a preferred embodiment, the method comprises the steps of rotating the indicator hand from a first position corresponding to a time prior to the upcoming alert setting to a next position corresponding to the upcoming alert setting; wherein the rotation of the indicator hand from the first position to the next position occurs automatically after the time corresponding to the first position and prior to the time corresponding to the next position. A multimode electronic device that indicates, with an indicator hand, one or more upcoming alert settings using the aforementioned methodology is also provided.

In a specific embodiment, the electronic device disclosed herein is preferably a timepiece.

### BRIEF DESCRIPTION OF THF DRAWINGS

For a fuller understanding of the invention, reference is had to the following description taken in connection with the accompanying figures, in which:

FIG. 1 is an exploded view of an electronic device constructed in accordance with the present invention;

FIG. 2 is a circuit diagram for an electronic device constructed in accordance with the present invention;

FIG. 3 is a block diagram of a controller, constructed in accordance with the present invention for use in an electronic device constructed in accordance with the present invention;

FIG. 4 is a top plan view of a wristwatch illustrating pushers to facilitate setting and viewing of the alert settings in accordance with the present invention; and

FIG. 5 and FIGS. 5A and 4B are top plan views of the electronic device constructed in accordance with the invention illustrated in FIG. 1, showing the indicator hand at various positions corresponding to different alert settings.

Identical reference numerals in the figures are intended to indicate like parts, although not every feature in every figure may be called out with a reference numeral.

### DESCRIPTION OF THE PREFERRED EMBODIMENTS

As set forth above, the present invention is directed to a method of setting and a method of viewing a plurality of alerts in a multimode electronic device, with a single indicator hand. Three major objectives are provided by the present invention and absent, to the inventor's knowledge, in the prior art. The first objective provides for the ability to set (and later view) multiple alert settings without the need for a separate indexing hand. The removal of this prior art feature permits for multiple (e.g. two or more, but as will be seen below, the real advantage of the present invention is to provide for significantly more) alert settings, since the prior art constrains a user to the number of alerts contemplated by the manufacturer, which amounts to very few, such as one or two. By removing this prior art constraint, the user is free to set many more than two (2) alert settings, as will become clearer below. Secondly, the use of a display (e.g. scale) which permits, with only a single indicator hand without a separate a.m./p.m. indicator, an alert to be set more than twelve (12) hours into the future is very advantageous and absent in the prior art. It is deemed to be the case that in the prior art for example, the desire to set an alert for the subsequent day must be effectuated that next day, since existing alarms (i.e. without an a.m./p.m. indicator hand) in the known analog watches do not readily display “a.m.” or “p.m.” And thirdly, the present invention provides for the automatic updating (e.g. rotation) of the indicator hand to the next upcoming alert, in order to provide a user with advance indication of the next alert setting. As indicated above, this is an advantageous in devices of the kind disclosed herein whereby more than one alert setting is storable and indicatable with an alert feature, such as an audible, visual and/or tactile indicator.

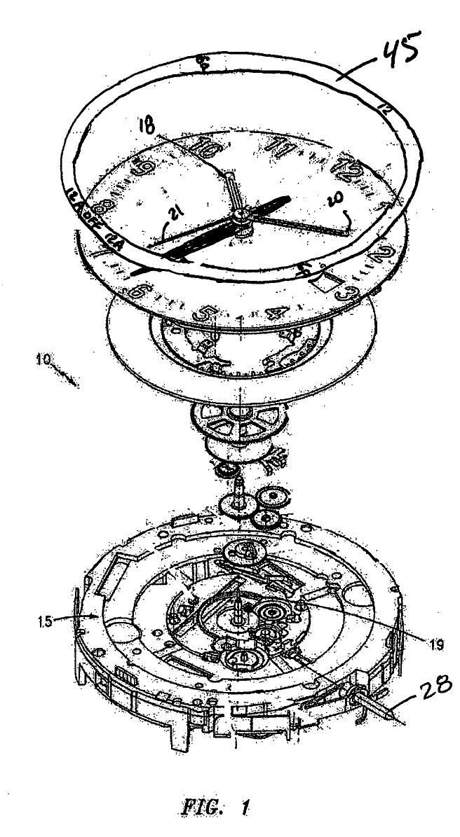

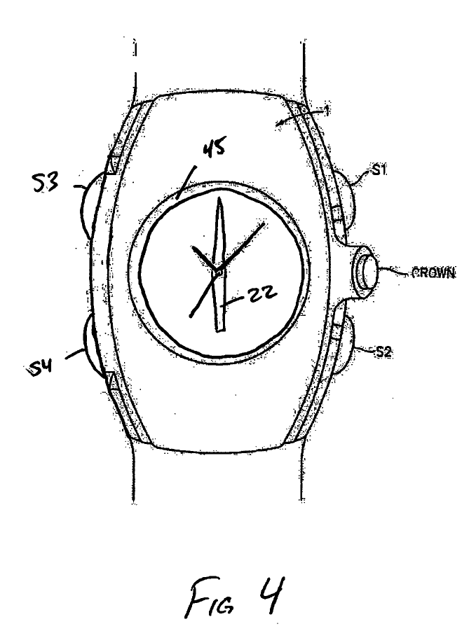

Reference is thus first made to FIG. 1, which is an exploded view of a multimode electronic device, generally indicated at 10, constructed in accordance with the present invention. In the preferred construction and as illustrated in FIG. 4, electronic device 10 is a timepiece, such as a wristwatch, generally indicated at 1, which itself will thus comprise other features and parts not necessarily relevant to the present invention and therefore not disclosed in detail for purposes of brevity. However, for such details, reference should be had to coowned and copending application Ser. No. 10/441,417, the disclosure of which is incorporated by reference as if fully set forth herein. This '417 application makes it clear that device 10 can be a heart rate monitor and/or a compass, just to name a few, all of which are clearly contemplated by device 10 herein. To be sure, all the devices that are disclosed in the aforementioned '417 are equally applicable to the present invention, and thus contemplated hereby.

Generally speaking, electronic device 10 comprises a module, generally indicated at 15, in which are disposed many components, the material ones of which pertain to the present invention being hereinafter disclosed, and it should be understood that the present disclosure will omit, for purposes of brevity, certain basic and very well known concepts regarding the construction of an analog and/or chronograph watch. For example, the basic construction and arrangements of gears and/or gear trains to rotate a plurality of “standard” hands all supported on a center stem 19, such as an hour hand 18, a minute hand 20 and a “seconds” hand 21, will be omitted as being well within the purview of one skilled in the art. Similarly, disclosure of the manual setting of such hands and the incorporation and construction of a preferred date wheel, are omitted herein as they form no part of the present invention. Therefore, the focus of the remaining portions of the specification will be to the best mode known and the disclosure necessary to completely enable one skilled in the art to construct an electronic device that incorporates the features and objectives of the present invention.

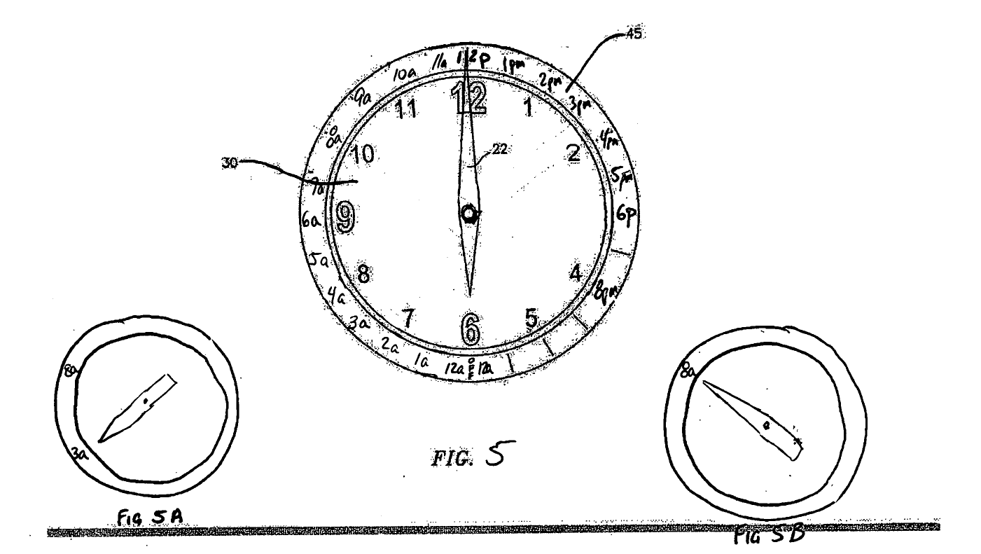

Electronic device 10 may comprise one or more “display hands” aside from the conventional hour, minute and “seconds” hand. For purposes of the present invention, reference will be made most particularly to display, or “indicator” hand 22, which in the embodiment of FIG. 1, is also mounted on center stem 19 and associated with a display ring 45 which may circumscribe dial 30, as illustrated in FIGS. 1, 5, 5A and 5B. To be sure, display ring 45 is a preferred implementation of the scale to which the claims refer. Likewise, the scale may in fact be provided (e.g. printed) on the face of the dial, if preferred or desired.

Reference may be made to the aforementioned '417 application for a more detailed understanding of the particular construction of all the components that make up module 15, although it should be within the purview of one skilled in the art to appreciate that the incorporation of an hour, minute and second hand, as well as a fourth “indicator” hand 22 will preferably require two actuation mechanisms, which in the preferred embodiment, are stepper motors. One skilled in the art would recognize that varying the number of displays and display hands can vary the number of needed stepper motors, all of which is within the scope of the present invention and disclosure and more particularly set forth in the '417 application. As set forth below, preferably there is a relationship control over the positioning of all the hands by the controller 100.

As positioned in module 15, the stepping motor and arrangement thereof to rotate hour hand 18, minute hand 20 and “seconds” hand 21 is well known. Specifically, hour hand 18, minute hand 20 and “seconds” hand 21 are coupled to a gear train for conveying the rotational activity generated by the rotor of its associated motor. In a similar manner, hand 22 is rotated by a stepper motor, and a gear train is similarly provided to convey the rotational activity generated by the rotor of motor thereof to hand 22. In the '417 application, the corresponding motor for hand 22 is motor M2. The construction of the respective gear trains are well within the purview of one ordinarily skilled in the art, and illustrated in greater detail in the aforementioned '417 application.

Preferably, the stepper motor associated with hand 22 is a bi-directional stepper motor thus being able to rotate in either direction, with as many as two rotor steps per revolution (or 180° per rotor step), and the construction of acceptable stepper motors to functionally operate in this manner are widely commercially available and well within the understanding of those skilled in the art. It should also be understood that it is well within the skill of the designer to design an appropriate gearing ratio to provide for the desirable display rotation or movement of display hand 22. That is, it may be desirable for the incremental rotation of hand 22 to be quite small, thus providing for precise increments and display capabilities. For example, in the preferred embodiment, which provides for display hand 22 to move in 15-minute increments, it is desirable to have very precise movement of hand 22, such as in 7.5° increments. Those skilled in the art can easily design the proper ratio of the gear train from its associated motor to achieve such movement. If the precision constraints were different, so would be the ratio of the gear train from the respective motor.

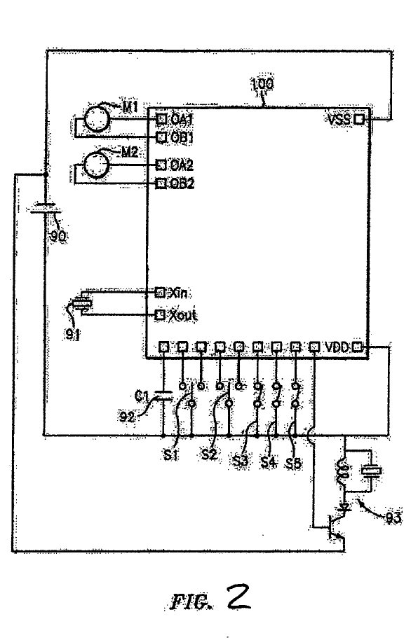

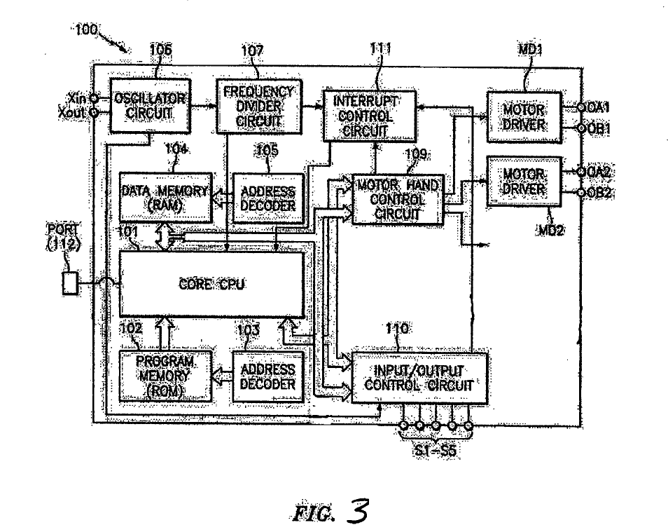

Reference is now made to FIG. 2, which illustrates a circuit diagram for a preferred construction of electronic device 10. Generally speaking, controller 100 is preferably an integrated microcontroller typically used with electronic watches which, as will be more particularly disclosed below with reference to FIG. 3, integrates onto a single chip, and includes a CPU core, a motor hand control circuit, an input/output control circuit, addressing and decoding functionality, memory and motor drivers, among other features not particularly relevant to the present invention.

As illustrated in FIG. 2, electronic device 10 includes, among other things, a battery 90, a resonator 91 to provide basic timing, a filter capacitor 92, interface connections to motors M1 and M2 and switches S1-S5. A well-understood circuit, generally indicated at 93, is provided for alert or “alarm” activation, and may include among other components, a piezoelectric buzzer which may be attached to the back cover of the watchcase. An audible alarm may be used in place of, or in addition to, the piezoelectric buzzer.

Switches S1-S5 are intended to generically indicate both side/top mounted pushers or crowns, or any other means that can be user actuated. Reference to such examples may be seen in U.S. application Ser. No. 09/359,223, the disclosure of which is thus incorporated by reference as if fully set forth herein. Such “switches” thus respond to the actuation (i.e. pulling and/or pushing) thereof. In the case of crowns, the pulling and or pushing actuations may be provided for setting hands 18, 20 and 21, setting alarm(s) and or actuating backlighting capabilities. In the case of top and/or side-mounted pushers, start/stop functions, mode selections, setting and viewing of alert settings and calibration of indicator hand 22 can be effectuated. Alternatively, use of the crown in a selected axial position can be used to effectuate rotation, calibration and/or setting of indicator hand 22 if done in a manner that permits the controller to maintain information of the position of hand 22. Of course combinations of the foregoing are within the purview of one skilled in the art. Details of such side pushers or crown actuations/constructions are believed to be within the purview of one skilled in the art.

Only a general reference shall be made to FIG. 3 as the details can also be found in the aforementioned '417 application. As illustrated, controller 100 comprises a core CPU 101 which itself comprises an ALU, a calculation register, a stack pointer, an instruction register and an instruction decoder. Controller 100 utilizes a memory mapped I/O bus 200 to communicate with hand control circuit 109 and input output control circuit 110.

A ROM memory block 102 in cooperation with an address encoder 103 provide access to electronic device control software and fixed data. The methodology for the programming for directing CPU 101 on the steps and logic necessary to keep track of and determine subsequent motor positions, as discussed further below, is also coded into ROM 102. Reference may also be made to copending application Ser. No. 10/090,588, the subject matter of which is incorporated by reference as if set forth herein, for a disclosure of a preferred construction for driving and controlling a plurality of stepper motors.

A RAM memory block 104, in cooperation with an address decoder 105, provides storage for intermediate calculation values and also is used to hold current position of the various electronic device hands, such as hands 18, 20, 21 and 22, and to store changeable information such as alert settings, which themselves may be downloaded into controller 100 through a port, generically indicated by 112, which may be an IR port, a keyboard input, a port for optical transmission, LEDs, RF, or through a wired link, such as a USB as but one example. Controller 100 includes oscillator circuit 106, which oscillates at a frequency determined by resonator 91, and a frequency divider circuit 107 divides the output of oscillator circuit 106 to generate appropriate timing signals for timekeeping, motor control and data acquisition functions.

A motor hand control circuit 109 receives a commanded “next number of pulses” from CPU core 101 and generates the pulsed and phased signals necessary to move a desired motor a desired amount and in a desired direction. Pulse outputs of the motor hand control circuit 109 are buffered by motor drivers MD1 and MD2 and applied to the motors associated with the respective hands.

An input/output control circuit 110 controls the crown actuations and pushbutton switches and provides such signaling information to CPU 101. An interrupt control circuit 111 is connected to frequency divider circuit 107, motor hand control circuit 109 and input/output control circuit 110, and outputs timer interrupts, motor control interrupts, and key interrupts to CPU 101.

Thus, controller 100 directly or indirectly controls the movement of indicator hand 22 and the indication and setting of alert settings. Controller 100 may have in its memory (or will be able to receive from an external source (such as via a telephone link, computer link, wirelessly, wired, or the like) for storage in such memory) alert settings if such are provided from an external source. Using a pusher to move hand 22 allows the controller to likewise maintain accurate positioning information of indicator hand 22, since the pusher will ultimately be providing signals to controller 100, which in turn controls the rotation of the stepping motor associated therewith.

As noted, analog hands 18, 20 and 21 are preferably used to indicate time and hand 22 is preferably used to indicate the current time of day and display values stored in RAM 104. As is also known to those skilled in the art, a stepper motor will remain in its last position unless pulsed to move. Therefore to smoothly display continuously varying information with an analog hand driven by a stepper motor, the preferred embodiment delivers to the stepper motor the necessary number of pulses to move the rotor of the stepper motor between a desired position at t=0, for example, and a position desired after some small time interval later.

Likewise, controller 100 preferably maintains information regarding the position of all the hands 18, 20, 21, 22 so that a manual adjustment of the hour/minute hand does not frustrate the relationship in positioning of hand 22 with respect thereto. Also preferably, the orientation of display dial 45 is calibrated with controller 100 so accurate alert settings indications can be made.

With the foregoing having provided a disclosure on how one can rotate display hand 22 and how signaling is inputted to controller 100 for communicating with motor hand control circuit 109 to cause the appropriate degree and direction of rotation of the rotors for the stepper motor associated therewith, reference is now made to the remaining figures and disclosure for an understanding of the preferred embodiments of the present invention.

Reference is now made to FIGS. 5 and 5A and 5B taken in connection with the following, for a disclosure of the preferred methodologies of the present invention. As can be seen in these figures, display dial 45 advantageously provides a 24-hour scale. In this first embodiment, a plurality of alerts are manually set in electronic device 10.

In this purely exemplary embodiment, indicator hand 22 is illustrated positioned essentially vertical (i.e. pointing to the 12:00 p.m. position). For convenience, it shall also be assumed for this example that the hour and minute hands (not shown) are indicating a time of day that is prior to 12:00 p.m. In this way, the indication of 12:00 p.m. by indicator hand 22 is intended to indicate that the next alert has been set for 12:00 p.m. (as mentioned below, indicator hand 22 may also be used as an alternate time-zone indicator whereby it will indicate the time-of-day in an alternate time zone, but use of indicator hand 22 in this way is merely intended to illustrate yet another advantage of the present invention). An “off” position is also provided, and positioned (for convenience) at the 6:00H position. This “off” position is preferably used as a “parking” place for indicator hand 22 when there are no future alerts that have been set or otherwise armed. In this way, an indicator hand 22 that points to the “off” position may indicate to the user that there are no alerts to be further actuated. It should also be appreciated that a separate mode could be incorporated to allow for daily alerts, if such alerts wish to be repeated on a subsequent day. In this way, the indication “off” may merely mean that there are no further alerts that are currently armed, although they would in fact be set. Arming alerts that are already set would provide for flexibility in turning off the indication of otherwise already set alerts. The present invention may also incorporate unique auto calibration algorithms and constructions to ensure that display hand is always positioned correctly, and reference may be had to U.S. patent application Ser. No. 10/737,406, the disclosure of which is incorporated by reference as if fully set forth herein.

In the preferred embodiment, indicator hand 22 is independently (vis a vis the hour and minute hands) keeping time, but as should be evident, not necessarily constantly indicating the actual time of day. In this way, the controller need not maintain proper position correspondence between the hour and minute hand on the one hand, and indicator hand 22 on the other. However, the more sophisticated design whereby the alert settings are only set and viewed by indicator hand 22 and the time of day is only maintained by the conventional hour and minute hands 18, 20 is clearly within the scope of the present invention.

To highlight the major advantages of the present invention, the example set forth herein assumes (again, only for convenience) that the actual time of day is prior to 12:00 p.m. (i.e. noon) and that it is desirable to set yet at least one additional alert. By way of example, two (2) additional alerts, namely at 3 a.m. and 8 a.m. (i.e. respectively more than fifteen (15) and twenty (20) hours into the future from the current time of being prior to 12:00 noon) shall be set by way of this example. Any alerts set for a time prior to the then current time of day will be assumed to be indicating an alert setting for the next day.

In this first embodiment, the invention comprises the steps of rotating indicator hand 22 to a position corresponding to a desired alert setting, which in the case of FIG. 5A, is the 3:00 a.m. position. Thus, in this example, it is desired to set an alert to sound, vibrate, illuminate and/or otherwise be indicated at 3:00 a.m. Therefore, the method comprises the step of setting an alert associated with the indicator hand being at the 3:00 a.m. position.

In distinction over the prior art, the present invention provides for setting at least two (2) alert settings with a single hand (i.e. without an alert indexer) prior to the indication of either the first or the second alerts. In the present example, the setting of the 12:00 noon alert (steps not shown for brevity) and the 3:00 a.m. alert settings constitutes the setting of more than one alert prior to the indication (e.g. alarm sound, visually indicate and/or via vibration) of either the first or the second alert. Furthermore, setting such alerts and/or viewing of the alert settings are provided (i) without a separate visual alert indexer to visually index alert settings such that the number of settable alerts is not dictated by the need to provide, or spacing requirements of, a visual alert indexer to correspondingly index the alert settings and/or (ii) at a future time more than twelve (12) hours subsequent to a then current (e.g. prior to 12:00 noon) time of day.

As set forth above, the present invention provides for the setting of yet additional (e.g. third, fourth, etc.) alerts, and therefore, the preferred methodology provides for the step of initiating a rotation of indicator hand 22 to a position corresponding to a third, forth, etc. alert setting, which can be prior to and/or after either the first or second alert settings, and setting such alert settings in a manner similar to those disclosed herein with respect to the first and setting alert settings. For example, the setting of the next (e.g. 8:00 a.m.) alert comprises the steps of rotating indicator hand 22 to the 8:00 a.m. position corresponding to the 8:00 a.m. alert (see FIG. 5B). In this example, it should also be understood that (i) if this 8:00 a.m. alert is set when the actual time of day is prior to 12:00 noon, the indicator hand 22 will be rotating to the 8:00 a.m. position from the current (i.e. next alert setting) indication of 12:00 noon; (ii) if this 8:00 a.m. alert is set when the actual time of day is subsequent to 12:00 noon but prior to 3:00 a.m. (i.e. the next alert after the 12:00 noon alert), the indicator hand 22 will be rotating to the 8:00 a.m. position from the next upcoming alert setting position (i.e. 3:00 a.m.) and (iii) if this 8:00 a.m. alert is set when the actual time of day is subsequent to 3:00 a.m. (i.e. the last alert setting), the indicator hand 22 may be rotating to the 8:00 a.m. position from the “off” position. Again, it is preferable that after all the alert settings have been indicated by alarm, indicator hand 22 will move to the “off” position if the alerts are not to be repeatable (i.e. each 24 hours), although if such alert settings have been set to be daily, the indicator hand may not need to rotate to the “off” position. Such software programming to achieve this feature is within the skill of the artisan.

The method concludes with the step of indicating at least one of the set alerts, such as visually, by feel (vibration) and/or by sound. Preferably, the method comprises the steps of indicating, at the appropriate times, the remaining alerts. In this way, device 10 can manually set multiple alerts occurring, for example, throughout a 24-hour period.

To be sure, the present invention permits for multiple alert settings and thus provides for the steps of rotating indicator hand 22 in predefined increments by repeated actuations of a user actuatable pusher or by rotating the rotateable setting stem as long as the controller maintains control of the associated motor positioning, temporarily terminating further rotation of the indicator hand; and setting an alert associated with indicator hand 22 being in the position after the temporary termination of rotation.

The foregoing methodology presumes that the alert settings are set manually, by way of one or more pushers, rotation of the setting stem in a selected axial position, a rotating bezel such as that described in U.S. Pat. Nos. 5,742,565 and 5,305,291 or any number of other user actuated mechanisms as set forth in the disclosures incorporated by reference herein. Alternatively, the alert settings could be externally inputted and stored in controller 100 as set forth above. A particular button sequence is provided below.

Complementing the just mentioned embodiment for setting multiple alerts, the present invention provides a unique methodology for the viewing, with indicator hand 22, a plurality of alert settings in device 10. Again, using the present Figures as illustrative and the foregoing example of multiple alerts (e.g. 12:00 noon, 3:00 a.m., 8:00 a.m.) having been set, the preferred method of viewing the alert settings comprises the steps of, and from an initial position (e.g. the next current alert setting (e.g. 12:00 p.m.)), initiating a rotation of indicator hand 22 to a position corresponding to the next alert setting (e.g. if the indicator hand is in the “off” position, by convention there are no further “armed” alert settings, although this “off” position could similarly be an initial position if the convention is such that the “off” position differentiates between “set and armed” and “set and unarmed” settings), which in the present example would be a rotation of indicator hand 22 from the position as set forth in FIG. 5 to that of 5A (i.e. from the 12:00 noon position to the 3:00 a.m. position).

To view any (and/or all) remaining alert setting, controller 100 initiates, from either the initial (e.g. the 12:00 noon) position or the position corresponding to the last displayed alert (e.g. 3:00 a.m.) setting, a rotation of the indicator hand to each subsequent alert setting, such as that illustrated by way of example in FIG. 5B (e.g. 8:00 a.m.). As indicated above, the rotation of indicator hand 22 to each of the alert settings can be done by actuation of one of the user-actuated means, such as one or more of the pushers. Clearly, the pusher can be actuated and released to initiate the movement of the hand 22 to the alert setting, or the pusher may be continually actuated, both of which are mere design choices. When indicator hand 22 reaches the alert setting, a vibration could occur and/or an alarm could sound indicating to the user that an alert setting is in fact set to be activated at that time. Alternatively, the indication of an alert setting can be visual such as by use of an “LED” which may be visible through the dial (not shown).

Several variations are provided. For example, the present invention provides for the step of rotating indicator hand 22 back to the next (e.g. 12:00 p.m.) alert setting position prior to the step of initiating a rotation of indicator hand 22 to a position corresponding to the 8:00 a.m. alert setting. The step of causing the rotation of indicator hand 22 back to the 12:00 noon position can be manually actuated, by way of actuation of a side or top pusher (S1-S5) or may occur automatically after a predetermined amount of time (e.g. three (3) seconds) from when hand 22 has been rotated to the position corresponding to the 3:00 a.m. alert setting. Controller 100 can maintain such timing of the hand rotation.

Likewise, the present invention includes the step of rotating indicator hand 22 back to the “initial” (e.g. 12:00 noon) position subsequent to the rotation of indicator hand 22 to the position corresponding to the 8:00 a.m. alert setting. In a similar manner, the step of causing the rotation of the indicator hand back to the 12:00 noon position can occur manually or may occur automatically after a predetermined amount of time from when hand 22 has been rotated to the position corresponding to the 8:00 a.m. alert setting.

Upon the actuation of one or more of the pushers S1-S5, indicator hand 22 will rotate to the next alert setting, i.e. to the 3:00 a.m. and/or 8:00 a.m. position from the 12:00 noon or “off” position. Preferably, there is an audible indication that indicator hand 22 has been rotated to a position corresponding to one of the alert settings. Likewise, a user actuated sequence of pushers may provide for indicator hand 22 to continuously rotate, with the audible alert only occurring temporarily as indicator hand 22 “passes by” the set alert setting. In a similar manner, the user could depress (e.g. once) the pusher to view all the set alerts, wherein the hand 22 would move from one to each subsequent alert setting, pausing at each, or a user could intermittently depress the pusher such that hand 22 would only move to the next alert setting.

In accordance with yet another feature of the present invention and to carry out the third major objective set forth herein, the present invention provides a method of automatically indicating, with indicator hand 22, an upcoming alert setting. That is, using the examples set forth above, assume that the time of day is now just subsequent to 12:00 noon (e.g. a few (e.g. 3) to many (e.g. 10) seconds) and the 12:00 noon alert has just been audibly, vibrationally and/or visually indicated. The present invention provides for the step of rotating indicator hand 22 from the (12:00 noon) position which, in the present example, corresponds to a time prior to the (3:00 a.m.) upcoming alert setting, to a next (e.g. the 3:00 a.m.) position corresponding to the next upcoming alert setting. Advantageously, this rotation of the indicator hand from the first (12:00 noon) position to the next (3:00 a.m.) position occurs automatically (i.e. without the need for the user to manually update indicator hand 22 to the next upcoming alert setting) after 12:00 noon and prior to 3:00 a.m. Preferably, this automatic rotation step occurs as soon as the 12:00 noon (visual/audible/vibratory) alert has been turned off, i.e. either having automatically timed out or after having been manually terminated.

Furthering the advantageousness of this embodiment, it can be seen that in the example where another alert setting corresponds to a time corresponding to the first-mentioned 12:00 noon position, the method also comprises the step of previously having rotated indicator hand 22 to the 12:00 noon position prior to the actual 12:00 time (e.g. the time corresponding to the another alert setting).

To be sure, in the aforementioned example where there is also an 8:00 a.m. alert setting (in addition to the exemplary 3:00 a.m. alert setting), the method comprises the steps of rotating indicator hand 22 from a first (e.g. the 3:00 a.m.) position corresponding to a time prior to an upcoming alert setting to a next (8:00 a.m.) position corresponding to at least a first of one or more upcoming alert settings, wherein the rotation of indicator hand 22 from the first (3:00 a.m.) position to the next (8:00 a.m.) position occurs automatically after 3:00 a.m. and prior to 8:00 a.m. Again, preferably this rotation occurs mere seconds after 3:00 a.m., such as after the alarm has self-timed out or has been manually terminated. In this way, there is a facilitation of the ability to see each of the one or more upcoming alert settings prior to the respective audible, visual or tactile indication thereof. In this way, the methodology and the electronic device provides a way to rotate the indicator hand to, and in advance of, the next alert setting, and preferably right after the actual time (e.g. time of day) passes the previously set alert setting.

That is, along with the foregoing methodologies, the present invention provides an electronic device for carrying out these methodologies. It is believed that the foregoing disclosure fully enables and discloses such a device, but in the interest of completeness, the following is set forth.

The figures illustrate multimode electronic device 10 having at least one indicator hand 22 operatively coupled to an actuation mechanism, and preferably a stepper motor, such as M2 in the aforementioned '417 application, for rotating indicator hand 22 in at least one of a first and second direction. To carry out the objectives of the present invention, multimode electronic device 10 comprises (i) means, which finds correspondence in the pushers, rotating the setting stem, or rotating bezel or other types of switching mechanisms in combination with controller 100, for causing the actuation mechanism (e.g. stepper motor) to rotate indicator hand 22 to one or more positions corresponding to desired alert setting; (ii) setting means, which finds correspondence again in the combination of the one or more pushers in combination with features of controller 100, for setting alerts associated with indicator hand 22 being in the one or more position; wherein the first means additionally causes the actuation mechanism to rotate indicator hand 22 to a second position corresponding to a second desired alert setting and wherein the setting means additionally sets a second alert associated with indicator hand 22 being in the second position; memory for storing at least the first and second alert settings; and indication means, such as a piezoelectric buzzer, an illuminable LED and/or an audible alarm, for indicating at least one of the first and second alerts. Constructed in this way, device 10 is capable of storing and indicating multiple alert settings with at least one indicator hand.

Consistent with all of the foregoing, the actuation mechanism rotates indicator hand 22 in predefined increments, preferably, but not necessarily, by repeated actuations of a user actuatable pusher, such as one or more of the pushers S1-S5. During setting for example, a user may move indicator hand 22 in the smallest increments available and/or achievable by the associated stepper motor. In a preferred embodiment, a user's repeated actuation of a pusher will rapidly move hand 22 in incremental steps, while continued (i.e. non-interrupted) actuation may more smoothly and still more rapidly advance the hand 22, with both methodologies providing for the pausing of the hand at any and all existing alert settings.

If properly constructed as set forth above, rotation of the setting stem in a particular axial position can also effectuate rotation of hand 22. Device 10 also provides the feature whereby the cessation of actuation of the user actuatable pusher causes the cessation of rotation of the indicator hand; and wherein the setting means sets an alert associated with the indicator hand being in the position after termination of rotation. Again, device 10 provides for the rotation of indicator hand 22 to a position corresponding to a third, fourth, fifth, etc. alert setting, and provides that the setting means sets an alert (such as by actuation of one of the selected pushers) associated with indicator hand 22 being in the respective positions corresponding to these additional alert setting.

Also consistent with the foregoing and in accordance with the present invention, device 10 provides for the indication, using indicator hand 22, of multiple alert settings, which have been set, such as for example, either manually or from an external source. To provide the foregoing, device 10 comprises actuation means (e.g. a stepping motor) operatively coupled to indicator hand 22, for rotating indicator hand 22 in at least one of a first and second direction; and means for initiating a rotation of the indicator hand from an initial position (e.g. 12:00 noon as an exemplary “next” alert setting) to a position corresponding to a next/first alert (e.g. 3:00 a.m.) setting and for initiating a rotation of the indicator hand to a position corresponding to a next/further alert (e.g. 8:00 a.m.) setting from either the aforementioned 12:00 noon position or the position corresponding to the 3:00 a.m. alert setting.

As set forth above with respect to the methodologies, device 10 provides for the rotating of indicator hand 22 back to the initial position (e.g. 12:00 p.m.) prior to initiating a rotation of indicator hand 22 to a position corresponding to the 8:00 a.m. alert setting. Such “initializing means” could comprise for example, an actuatable pusher that upon actuation, causes the rotation of indicator hand 22 back to the initial position or could be performed by the controller itself, after a predetermined amount of time (e.g. 3 seconds) from when hand 22 has been rotated to the position corresponding to the 3:00 a.m. alert setting. Obviously as well, indicator hand 22 could be rotated back to the initial position subsequent to the rotation of the indicator hand to the position corresponding to the 8:00 a.m. alert setting, and can be done manually or automatically, as disclosed above.

With respect to the aforementioned third main objective of the present invention, the multimode electronic device of the present invention includes rotating means coupled to the indicator hand, for rotating the indicator hand; a controller operatively coupled to the rotating means for controlling the rotation of the indicator hand and for maintaining time information; wherein the indicator hand is rotated from a first position corresponding to a time prior to an upcoming alert setting to a next position corresponding to at least a first of the one or more upcoming alert settings; wherein the rotation of the indicator hand from the first position to the next position occurs automatically after the time corresponding to the first position and prior to the time corresponding to the next position; thereby there is facilitation of the ability to see each of the one or more upcoming alert setting prior to a respective audible, visual or tactile indication thereof. Advantageously, the electronic device may have stored therein multiple upcoming alert settings, and wherein the controller causes the rotation of the indicator hand from one previous alert setting to the next one, wherein the rotation of the indicator hand from the one alert setting position to the next alert setting position occurs automatically and subsequent to the time corresponding to the first position and prior to the time corresponding to the next position. This feature is particularly advantageous when the device has been programmed or otherwise has stored therein multiple alert settings, such as having been downloaded from a PC or otherwise.

More specifically and in accordance with a still further detailed embodiment, a user may set/clear an alert with the following procedure: (i) pull the crown to a “set1” position; (ii) press another side pusher (e.g. an “up arrow”) button to move indicator hand 22 in predefined (e.g. 15-minute) increments clockwise, wherein holding the “up arrow” button moves the indicator hand continuously, pausing at any alarm times that have been set; (iii) an alarm status indication would indicate whether an alarm is set for the time pointed to by indicator hand 22; (iv) pressing the “on/off” button respectively sets/clears an alarm for the indicated time; and pushing the crown in (e.g. from the “set1” position to the normal “run” position) when done.

As indicated above, indicator hand 22 is preferably also set to the accurate time of day, which may preferably be achieved by the following procedure: (i) pull the crown to a “set2” position; (ii) the indicator hand 22 moves to an “initial” position, automatically calibrating itself; (iii) the indicator hand 22 then moves to indicate the current time on the 24-hour scale; (iv) pressing the “up/down” arrow buttons to change the time of day in one-hour increments; (v) pressing a dedicated side pusher if the minutes need to be set; (vi) the indicator hand 22 moves to indicate the current minutes on the 12-hour scale; (vii) pressing the “up/down” arrow buttons to make the indicator hand 22 match the minute hand; and (viii) pushing the crown in to its normal run position when completed.

Device 10 also preferably includes means for audibly indicating that the indicator hand has been rotated to a position corresponding to an alert setting. As another feature, such indication means, whether a piezoelectric buzzer or other alarm (e.g. vibration), can be enabled so as to audibly indicate that the indicator hand has been rotated to a position corresponding to an alert setting; and disabled so as to disable the audible indication that the indicator hand has been rotated to a position corresponding to an alert setting. In such a case, a visual indicator could be used in place thereof.

In yet an alternative embodiment, indicator hand 22 can display information relating to a second time zone. In a design more indicative of a “Traveler” watch, a mode button could be provided to select whether the indicator hand 22 is displaying the alert setting or the second time zone. Yet another hand could be provided to indicate the mode. The design could also be used to combine multiple alerts with other features that could employ the indicator hand 22, as disclosed in the aforementioned '417 application.

While the invention has been particularly shown and described with respect to preferred embodiments thereof, it will be understood by those skilled in the art that changes in form and details may be made therein without departing from the scope and spirit of the invention.

For example, pressing a particular pusher (e.g. S2, FIG. 4) could cause the device to display the current day's next alarm, relative to the last displayed alarm, for some amount of time before returning to the standard display of the next upcoming alarm. If for example, the device had alarms set for 8:00 a.m. 12:00 p.m., and 2:00 p.m., and the current time was 7:00 a.m., indicator hand 22 would point to the 8:00 a.m. position. Pressing another of the switches (e.g. S4, FIG. 4) would cause the device to move indicator hand 22 to the 12:00 p.m. position, the time of the next alarm. The hand would preferably return to 8:00 a.m. after some number of seconds, or the user could press S1 again to display the next alarm (2:00 p.m.). As but one example, pressing S4 would alternately enable and disable the audible alert for all alarms.

Using the axial positioning of the setting stem 28 to provide further options, in a first axial position pressing S2 could move indicator hand 22 clockwise in increments of 15 minutes, and an audible beep could occur when indicator hand 22 is moved to a time with an alert time that has been set. Similarly, pressing S4 could alternately arm and disarm the alert for the indicated time.

In another axial position of setting stem 28, a user may set the time of day and, if necessary, calibrate indicator hand 22. S4 could be used to switch between those two operations. Pressing S2 could move hand 22 clockwise to indicate the current time of day or calibrate the hand to a particular location.

In an embodiment where date data is received from another device, the watch could store alarms with dates associated with them, and display only alarms for the current date, thus making the manual setting of alarms unnecessary.

As such, it can be seen that in the broadest of embodiments, the present invention provides for up to, for example, 96 alert settings with 15-minute resolution, each of which would be set and/or viewed in the manner set forth herein. In fact, smaller resolution would provide for yet additional alert setting capability. Moreover, the present invention permits alert settings up to 24 hours into the future without the need for a second a.m./p.m. indication hand.

Lastly, references to “first” and “next” should be interpreted as being synonymous since the foregoing example highlights an exemplary illustration wherein an initial alert (i.e. 12 noon) has been set. From the 12 noon position, all subsequent settings would be the “next” setting, although from the “off” position, the “next” setting could and/or would be the “first” setting. The claims should not therefore be limited thereby.

What is claimed is:

1. A method of manually setting a plurality of alerts in a multimode electronic device, wherein the method is achieved with a single indicator hand without a separate visual alert indexer to visually index alert settings, wherein the method comprises the steps of:
rotating an indicator hand to a first position corresponding to a first desired alert setting;
setting a first alert associated with the indicator hand being in the first position;
rotating the indicator hand to a second position corresponding to a second desired alert setting; and
setting a second alert associated with the indicator hand being in the second position;
wherein the settings for both the first alert and the second alert are stored prior to the indication of either the first and second alerts;
wherein the number of settable alerts is not dictated by the need to provide, or spacing requirements of, a visual alert indexer to correspondingly index the alert settings.

2. The method as claimed in claim 1, including the step of audibly indicating the alerts.

3. The method as claimed in claim 1, wherein the step of rotating the indicator hand includes the step of rotating the indicator hand in predefined increments by repeated actuations of a user actuatable pusher.

4. The method as claimed in claim 3, including the steps of:
temporarily terminating further rotation of the indicator hand; and
setting an alert associated with the indicator hand being in the position after the temporary termination of rotation.

5. A method of viewing, with an indicator hand, at least a first and a second alert setting in a multimode electronic device, the method comprising the steps of:
from an initial position, initiating a rotation of the indicator hand to a position corresponding to the first alert setting; and
from either the initial position or the position corresponding to the first alert setting, initiating a rotation of the indicator hand to a position corresponding to the second alert setting;
wherein all alerts are viewed with a single indicator hand without a separate visual alert indexer to visually index the alert settings.

6. The method as claimed in claim 5, including the step of rotating the indicator hand back to the initial position prior to the step of initiating a rotation of the indicator hand to a position corresponding to the second alert setting.

7. The method as claimed in claim 6, including the step of manually causing the rotation of the indicator hand back to the initial position.

8. The method as claimed in claim 6, including the step of rotating the indicator hand back to the initial position occurs automatically after a predetermined amount of time from when the hand has been rotated to the position corresponding to the first alert setting.

9. The method as claimed in claim 5, including the step of rotating the indicator hand back to the initial position subsequent to the rotation of the indicator hand to the position corresponding to the second alert setting.

10. The method as claimed in claim 9, including the step of manually causing the rotation of the indicator hand back to the initial position and/or rotating the indicator hand back to the initial position occurs automatically after a predetermined amount of time from when the hand has been rotated to the position corresponding to the second alert setting.

11. The method as claimed in claim 5, including the step of initiating a rotation of the indicator hand to a position corresponding to a third alert setting.

12. The method as claimed in claim 5, including the step of audibly indicating that the indicator hand has been rotated to a position corresponding to one of the first and second alert settings.

13. The method as claimed in claim 5, wherein the at least first and second alert settings are provided by an external source and downloaded into the electronic device for viewing.

14. A multimode electronic device having at least one indicator hand operatively coupled to an actuation mechanism for rotating the indicator hand in at least one of a first and second direction, wherein the multimode electronic device comprises:
viewable demarcations spanning a time-period of greater than twelve (12) hours;
means for causing the actuation mechanism to rotate the indicator hand from an initial position to a first position corresponding to a first desired alert setting, wherein the desired alert setting corresponds to a time that is more than twelve (12) hours subsequent to a time represented by the initial position;
means for setting a first alert associated with the indicator hand being in the first position;
wherein the first alert activates at a time that is more than twelve (12) hours subsequent to the time represented by the initial position;
wherein only a single indicator hand is used without a separate am/pm indicator to indicate whether the indicator hand is indicating an alert setting that is greater than 12 hours subsequent to the time represented by the initial position.

15. The device as claimed in claim 14, wherein the demarcations are provided on the bezel.

16. The device as claimed in claim 14, wherein the demarcations are provided on the surface of the dial.

17. The device as claimed in claim 14, including up to 96 alert settings with 15-minute resolutions.

18. A method of indicating, with an indicator hand, an upcoming alert setting in a multimode electronic device, the method comprising the steps of:
rotating the indicator hand from a first position corresponding to a time prior to the upcoming alert setting to a next position corresponding to the upcoming alert setting;
wherein the rotation of the indicator hand from the first position to the next position occurs automatically after the time corresponding to the first position and prior to the time corresponding to the next position.

19. The method as claimed in claim 18, wherein another alert setting corresponds to a time corresponding to the first position, and wherein the method comprises the steps of:
rotating the indicator hand to the first position prior to the time corresponding to the another alert setting.

20. A multimode electronic device that indicates, with an indicator hand, one or more upcoming alert settings prior to the time corresponding to each of the one or more upcoming alert settings, wherein the multimode electronic device comprises:
rotating means coupled to the indicator hand, for rotating the indicator hand;
a controller operatively coupled to the rotating means for controlling the rotation of the indicator hand and for maintaining time information;
wherein the indicator hand is rotated from a first position corresponding to a time prior to an upcoming alert setting to a next position corresponding to at least a first of the one or more upcoming alert settings;
wherein the rotation of the indicator hand from the first position to the next position occurs automatically after the time corresponding to the first position and prior to the time corresponding to the next position;
whereby there is facilitation of the ability to see each of the one or more upcoming alert setting prior to a respective audible, visual or tactile indication thereof.

21. The electronic device as claimed in claim 20, wherein the electronic device has stored therein at least a second upcoming alert setting, and wherein the controller causes the rotation of the indicator hand from the next position to a further next position corresponding to the at least second upcoming alert setting;
wherein the rotation of the indicator hand from the next position to the further next position occurs automatically and subsequent to the time corresponding to the next position and prior to the time corresponding to the further next position;
whereby there is facilitation of the ability to see the second upcoming alert setting prior to an audible, visual or tactile indication thereof.
